(19) United States
(12) Patent Application Publication
(10) Pub. No.: US 2016/0360077 A1
(43) Pub. Date: Dec. 8, 2016

(54) IMAGING DEVICE BODY AND IMAGING DEVICE

(71) Applicant: PANASONIC INTELLECTUAL PROPERTY MANAGEMENT CO., LTD., Osaka (JP)

(72) Inventor: Ryotaro MIURA, Osaka (JP)

(21) Appl. No.: 15/239,562

(22) Filed: Aug. 17, 2016

Related U.S. Application Data
(63) Continuation of application No. PCT/JP2015/004834, filed on Sep. 24, 2015.

(30) Foreign Application Priority Data
Mar. 19, 2015 (JP) 2015-056735

(51) Int. Cl. H04N 5/225; G02B 7/14

(52) U.S. Cl. CPC H04N 5/2254; H04N 5/2253; G02B 7/14; H04N 5/2252

(57) ABSTRACT

An imaging device body includes a case, a mount ring to which a lens unit is mountable, a mount base disposed on a back side of the mount ring and configured to attach the mount ring to the case, a heat sink disposed on a back side of the mount base, an image sensor element that is attached to a front side of the heat sink and images an optical image of a subject to generate image data, a first screw member that has a head disposed on a back side of the case and the mount base and attaches the mount base to the case, and a first buffer member disposed between the head of the first screw member and the mount base.

### BACKGROUND

1. Technical Field

The present disclosure relates to an imaging device body to which an interchangeable lens unit is mountable, and an imaging device including the imaging device body and the interchangeable lens unit.

2. Description of the Related Art

Unexamined Japanese Patent Publication No. 2005-284147 (Patent Literature 1) discloses a structure that, in a cellular phone with an imaging device module, buffers vibration and impact conveyed to the imaging device module to prevent breakage when the cellular phone falls down. Specifically, the imaging device module of the cellular phone described in Patent Literature 1 has an image sensor element and lens combination, which is integrally constituted, and is mounted in a mounting board. The mounting board is attached to an exterior cover by using a screw with buffer members, such as rubber and sponge, interposed therebetween.

### SUMMARY

The present disclosure is directed to an imaging device body to which an interchangeable lens unit is mountable. The imaging device body includes a case, a mount ring to which the lens unit is mountable, a mount base disposed on a back side of the mount ring and configured to attach the mount ring to the case, a heat sink disposed on a back side of the mount base, an image sensor element that is attached to a front surface of the heat sink and images an optical image of a subject to generate image data, a first screw member that has a locking part disposed on a back side of the case and the mount base and attaches the mount base to the case, and a first buffer member disposed between the locking part of the first screw member and the mount base.

This configuration makes it possible to provide an imaging device body capable of preventing a change in a flange back due to impact by a fall or the like, and an imaging device.

### BRIEF DESCRIPTION OF DRAWINGS

FIG. 1 is an overall perspective view of an imaging device according to a first exemplary embodiment;

FIG. 2 is an overall perspective view of an imaging device body according to the first exemplary embodiment;

FIG. 3 is a front view of the imaging device body according to the first exemplary embodiment;

FIG. 4A is a schematic diagram showing a horizontal cross-section around the periphery of a mount ring of the imaging device body taken along line A-A in FIG. 3;

FIG. 4B is a view showing a state of the imaging device when impact is applied to the imaging device due to a fall;

FIG. 5A is a schematic diagram showing a horizontal cross-section around the periphery of a mount ring of an imaging device body according to a second exemplary embodiment;

FIG. 5B is a view showing a state of the imaging device when impact is applied to the imaging device due to a fall;

FIG. 5C is a view showing a state of the imaging device when impact is applied to the imaging device due to a fall;

FIG. 6A is a schematic diagram showing a horizontal cross-section around the periphery of a mount ring of an imaging device body according to a third exemplary embodiment;

FIG. 6B is a view showing a state of the imaging device when impact is applied to the imaging device due to a fall;

FIG. 6C is a view showing a state of the imaging device when impact is applied to the imaging device due to a fall;

FIG. 6D is a view showing a state of the imaging device when impact is applied to the imaging device due to a fall; and

FIG. 7 is a schematic diagram showing a horizontal cross-section around the periphery of a mount ring of an imaging device body according to a fourth exemplary embodiment.

### DETAILED DESCRIPTION OF THE PREFERRED EMBODIMENTS

Hereinafter, exemplary embodiments will be described in detail with reference to the drawings as necessary. However, detailed description more than necessary may be omitted. For instance, detailed description about well-known matter and overlapped description about substantially the same configuration may be omitted. This is to prevent the following description from being unnecessarily redundant, so as to facilitate understanding of a person skilled in the art.

Note that, the applicant provides the accompanying drawings and the following description in order for a person skilled in the art to fully understand the present disclosure, and do not intend to limit the subject matter recited in claims by the accompanying drawings and the following description.

### BACKGROUND OF THE DISCLOSURE

In recent years, in an imaging device to which an interchangeable lens unit is mountable, a lens aperture of the lens unit is enlarged as the imaging device is enlarged by using a full-sized image sensor element or the like, so that lens weight tends to be increased. Further, the imaging device body tends to be miniaturized and slimmed down. For these reasons, a centroid position of the imaging device with the lens unit mounted tends to move to a lens unit side. According to such a tendency, if an imaging device is fallen down due to user's carelessness or the like, the imaging device falls down in the state where the lens unit side remains located below an imaging device body side, so that the lens unit side is likely to collide with a floor.

Here, in the imaging device including an imaging device body to which the interchangeable lens unit is mountable, an image sensor element is mounted on an imaging device body side. That is, the lens and the image sensor element are constituted separately. Accordingly, when impact is applied to the imaging device due to a fall or the like, the impact may deform a lens unit supporting part or the like on the imaging device body side and change a flange back between the lens unit and the image sensor element.

### First Exemplary Embodiment

Hereinafter, a first exemplary embodiment will be described with reference to the drawings.

### [1-1. Structure]

### [1-1-1. Schematic Structure of an Imaging Device Body]

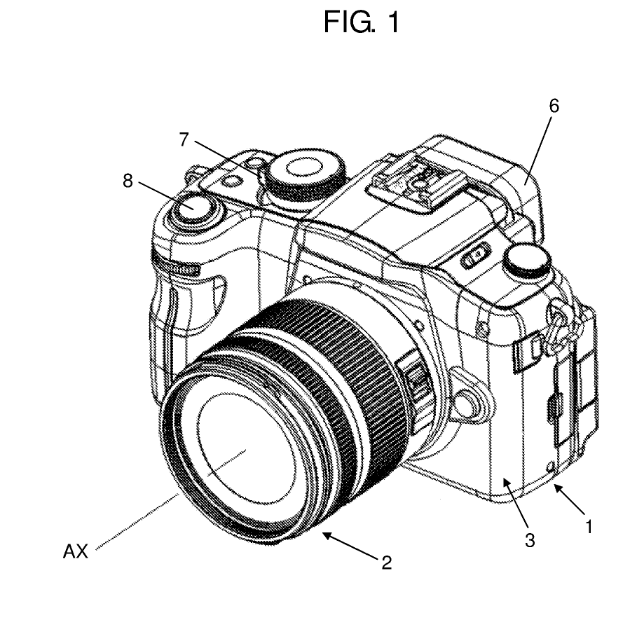

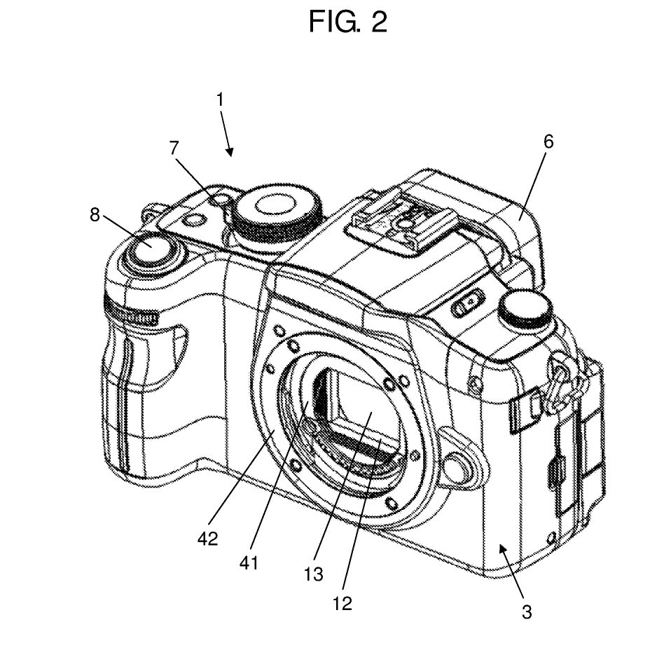

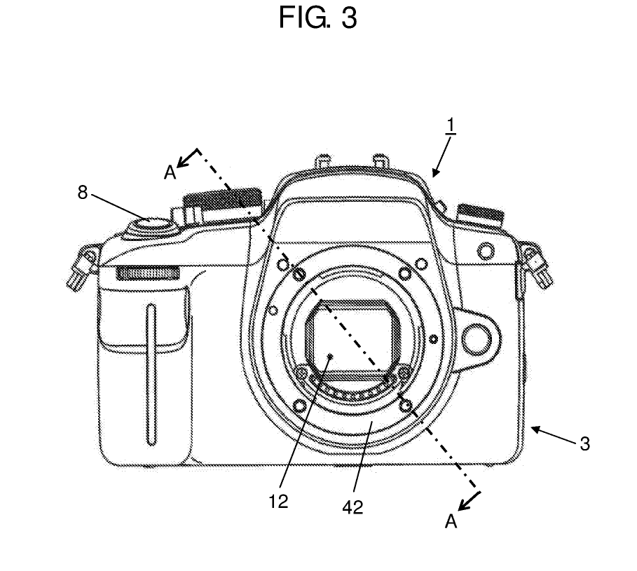

FIG. 1 is an overall perspective view of an imaging device according to the first exemplary embodiment. FIG. 2 is an overall perspective view of an imaging device body according to the first exemplary embodiment. FIG. 3 is a front view of the imaging device body according to the first exemplary embodiment. Herein, FIG. 1 shows the imaging device with a lens unit mounted, and FIGS. 2 and 3 show the imaging device with the lens unit removed. Hereinafter, each part will be described in detail.

The imaging device is a lens-interchangeable type digital imaging device. The imaging device includes imaging device body 1 and lens unit 2 that is mountable to imaging device body 1. Lens unit 2 includes a plurality of lenses and an image stabilization mechanism.

Control lever 7, release button 8, electronic view finder 6, and the like are disposed on an upper surface of imaging device body 1.

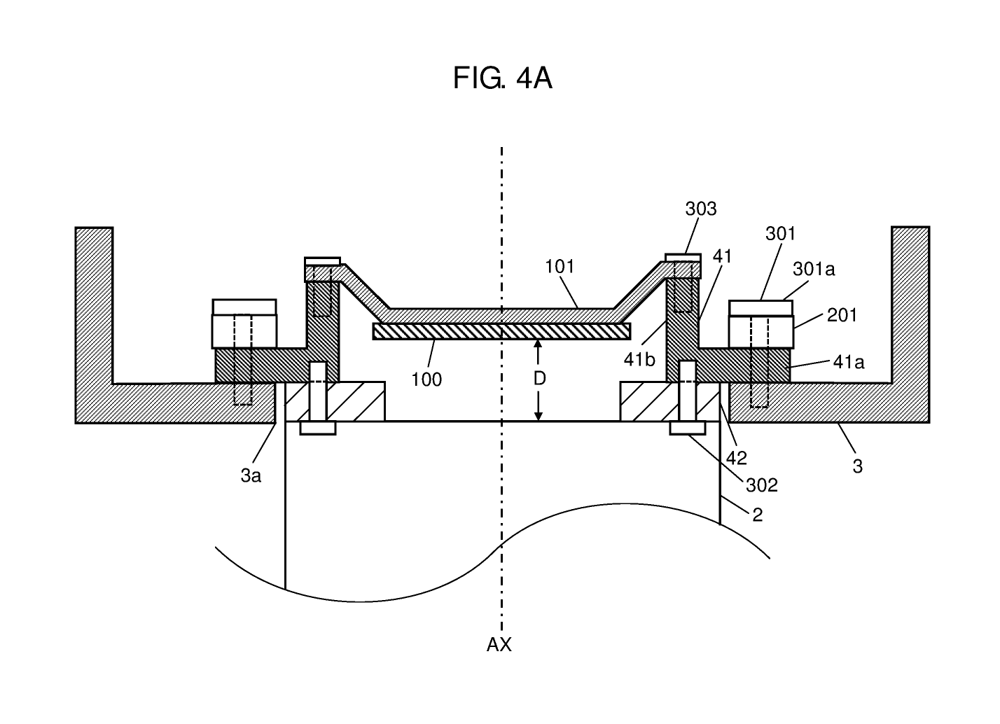

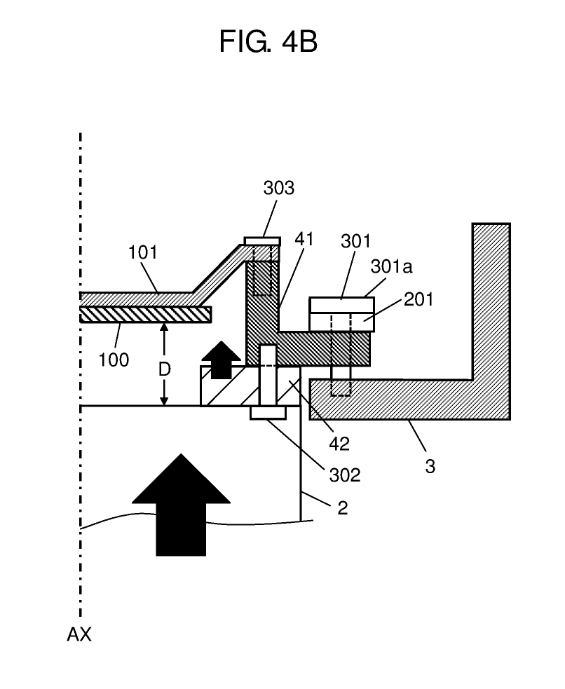

Mount ring 42 to which lens unit 2 is mountable is disposed on a front surface of imaging device body 1. Mount ring 42 is disposed in circular opening part 3a (see FIG. 4A) that is formed in case 3 of imaging device body 1. Lens unit 2 fixed to mount ring 42 is held to have a predetermined positional relationship relative to imaging device body 1.

Shutter unit 12, vibrating plate 13 for preventing dust adhesion, image sensor element 100, and the like are disposed inside imaging device body 1.

### [1-1-2. Structure Around the Periphery of a Mount Ring of an Imaging Device Body]

FIG. 4A is a schematic diagram showing a horizontal cross-section around the periphery of the mount ring of imaging device body 1 taken along line A-A in FIG. 3. Specifically, FIG. 4A is a view showing a state of the imaging device when no impact is applied to the imaging device.

Imaging device body 1 has mount base 41, heat sink 101, and image sensor element 100 in the periphery of mount ring 42.

Mount base 41 is a member for attaching mount ring 42 to case 3. Mount base 41 is disposed on a back side of mount ring 42. Mount base 41 is attached to case 3 with first screw member 301. Specifically, first screw member 301 is disposed such that its axial direction is aligned with a direction parallel to an optical axis AX direction, and an end part thereof is screwed in case 3.

Mount ring 42 is a member to which a lens mount of lens unit 2 is mountable.

Heat sink 101 is a member for dissipating heat generated in image sensor element 100. Heat sink 101 is disposed such that flange parts serving as its both ends are located on a back side of mount base 41.

Image sensor element 100 images an optical image of a subject to generate image data. Image sensor element 100 is a full-sized CMOS sensor with a photographing area of 36 mm wide×24 mm long, or a CCD sensor, for example. Note that, in the present disclosure, the image sensor element is not limited to a full-sized image sensor element, but may be the other size image sensor element. Image sensor element 100 is attached to a front side of heat sink 101 to have predetermined flange back D. For the way how to attach image sensor element 100, any other structure may be employed as long as the heat generated in image sensor element 100 can be conducted to heat sink 101.

### [1-1-3. Mounting Structure]

### [1-1-3-1. Structure of Attaching a Mount Ring to a Mount Base]

Mount ring 42 is attached to first screw boss part 41a of mount base 41 from a front side of mount ring 42 with second screw member 302. Specifically, mount ring 42 has a screw insertion hole formed therethrough in the optical axis AX direction. A diameter of the screw insertion hole is slightly larger than that of a screw shaft part of second screw member 302, and enough for second screw member 302 to move through the screw insertion hole in its axial direction. Note that, in the figure, the screw insertion hole is overlapped with the screw shaft part of second screw member 302; therefore reference numerals are not assigned in particular. Second screw member 302 is inserted into the screw insertion hole of mount ring 42, and a thread part serving as an end part is screwed in mount base 41.

### [1-1-3-2. Structure of Attaching a Mount Base to the Case]

Mount base 41 is attached to case 3 with first screw member 301 on an inner surface side of first screw boss part 41a. Specifically, mount base 41 has a screw insertion hole formed therethrough in the optical axis AX direction. A diameter of the screw insertion hole is slightly larger than that of a screw shaft part of first screw member 301, and enough for first screw member 301 to move through the screw insertion hole in its axial direction. Note that, in the figure, the screw insertion hole is overlapped with the screw shaft part of the first screw member 301; therefore reference numerals are not assigned in particular. First screw member 301 is inserted into the screw insertion hole of mount base 41, and a thread part serving as an end part is screwed in case 3.

In the first exemplary embodiment, first buffer member 201 is disposed between head 301a of first screw member 301 and first screw boss part 41a of mount base 41. First screw member 301 is inserted through first buffer member 201. First buffer member 201 is formed of elastic hard rubber (e.g., silicon rubber). First buffer member 201 is disposed between head 301a of the first screw member 301 and first screw boss part 41a of mount base 41 in the state where being compressed. Note that, in the present disclosure, first buffer member 201 may be formed of a coil spring. The compression state of the first buffer member 201 is adjusted by moving first screw member 301 forward and backward in the axis direction. Further, for instance, whether the hard rubber or the coil spring is employed can be determined based on whether a hard rubber or a coil spring can be disposed in accordance with a distance between head 301a of first screw member 301 and first screw boss part 41a of mount base 41.

### [1-1-3-3. Structure of Attaching a Heat Sink to the Mount Base]

Heat sink 101 is attached to a rear end portion of second screw boss part 41b of mount base 41 with third screw member 303. Specifically, heat sink 101 has a screw insertion hole formed therethrough in the optical axis AX direction. A diameter of the screw insertion hole is slightly larger than that of a screw shaft part of third screw member 303, and enough for third screw member 303 to move through the screw insertion hole in its axial direction. Note that, in the figures, the screw insertion hole is overlapped with the screw shaft part of third screw member 303; therefore reference numerals are not assigned in particular. Third screw member 303 is inserted into the screw insertion hole of heat sink 101, and a thread part serving as an end part is screwed in second screw boss part 41b.

### [1-1-3-4. Position of a Screw Insertion Hole for Each Screw Member]

A position of screw insertion hole for each screw member is determined such that an axial center position of first screw member 301, an axial center position of second screw member 302, and an axial center position of the third screw member 303 are not overlapped with one another in a plane perpendicular to the optical axis AX direction. The axial center position of the first screw member 301 is determined to be farther from optical axis AX than the axial center position of second screw member 302 and the axial center position of third screw member 303 are.

### [1-2. Operation]

The case where the imaging device is fallen down due to user's carelessness or the like will be described with reference to FIG. 4B. FIG. 4B is a view showing a state of the imaging device when impact is applied to the imaging device due to a fall. Note that, the cross-section position is a position indicated by line A-A in FIG. 3.

Due to such a reason mentioned above, when being fallen down, the imaging device falls down in the state where a lens unit 2 side remains located below an imaging device body 1 side. For that reason, an end part side of lens unit 2 collides with a floor, and impact may often be applied to lens unit 2, firstly. In this way, the impact applied to lens unit 2 is conveyed to mount ring 42, and further conveyed to mount base 41 via mount ring 42. A back side of first buffer member 201 that is disposed on a back side of first screw boss part 41a of mount base 41 is in contact with head 301a of first screw member 301. Accordingly, mount base 41 elastically deforms first buffer member 201 in a compressed direction while sliding rearward in the optical axis AX direction. That is, first buffer member 201 absorbs the impact to some extent when mount base 41 slides rearward in the optical axis AX direction. Accordingly, the impact is prevented from concentrating on a joined portion between first screw boss part 41a of mount base 41 and case 3. This prevents that the impact deforms the joined portion and its vicinity between mount base 41 and case 3 or the like. After absorbing the impact, first buffer member 201 returns to the compression state shown in FIG. 4A. Thus, flange back D is prevented from being changed with respect to the state before the imaging device is fallen down.

If first buffer member 201 is absent, when the imaging device is fallen down and impact is applied to lens unit 2 as mentioned above, the impact caused by weight of the imaging device or the like is concentrated on the joined portion between first screw boss part 41a of mount base 41 and case 3. This deforms the above joined portion and its vicinity, so that flange back D is likely to be changed with respect to the state before the imaging device is fallen down. However, the first exemplary embodiment prevents such a change in flange back D.

### [1-3. Effect and the Like]

To imaging device body 1 of the first exemplary embodiment, interchangeable lens unit 2 is mountable. Imaging device body 1 includes case 3, mount ring 42 to which lens unit 2 is mountable, mount base 41 disposed on a back side of mount ring 42 and configured to attach mount ring 42 to case 3, heat sink 101 disposed on a back side of mount base 41, image sensor element 100 that is attached to a front side of heat sink 101 and images an optical image of a subject to generate image data, and head 301a (locking part) disposed on a back side of case 3 and mount base 41. Imaging device body 1 further includes first screw member 301 (first screw member) for attaching mount base 41 to case 3, and first buffer member 201 disposed between head 301a of the first screw member 301 and mount base 41.

Thus, even if impact is applied to mounted lens unit 2 due to a fall or the like, the impact applied to support members such as mount ring 42, mount base 41, and first screw member 301 is absorbed. For that reason, deformation of each support member is prevented. Accordingly, a change in flange back D due to impact caused by a fall or the like is prevented.

The imaging device of the first exemplary embodiment is an imaging device including imaging device body 1 and interchangeable lens unit 2 being mountable to mount ring 42.

Thus, above-mentioned effects are expected in the imaging device including imaging device body 1 and interchangeable lens unit 2 being mountable to mount ring 42.

### Second Exemplary Embodiment

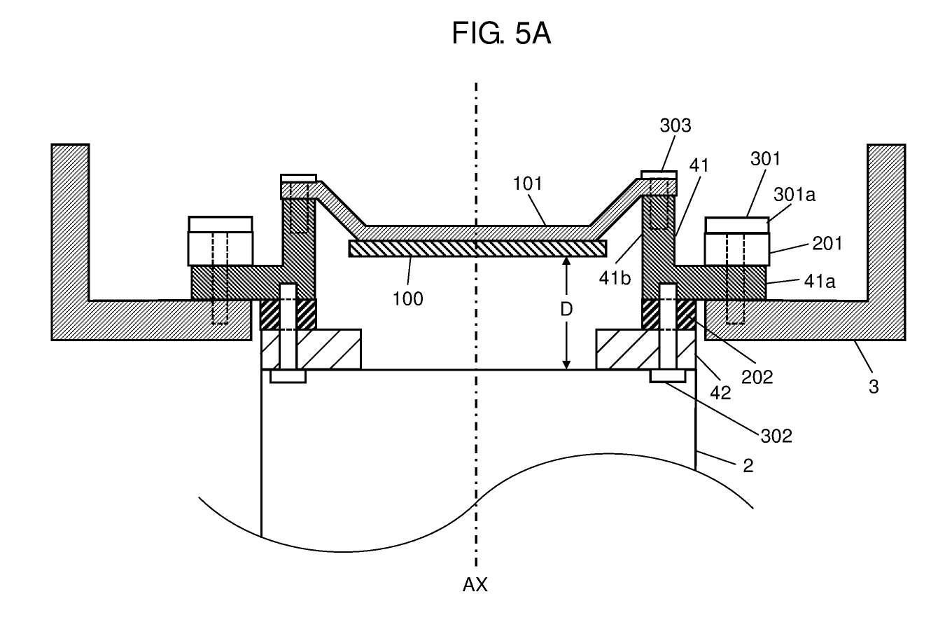

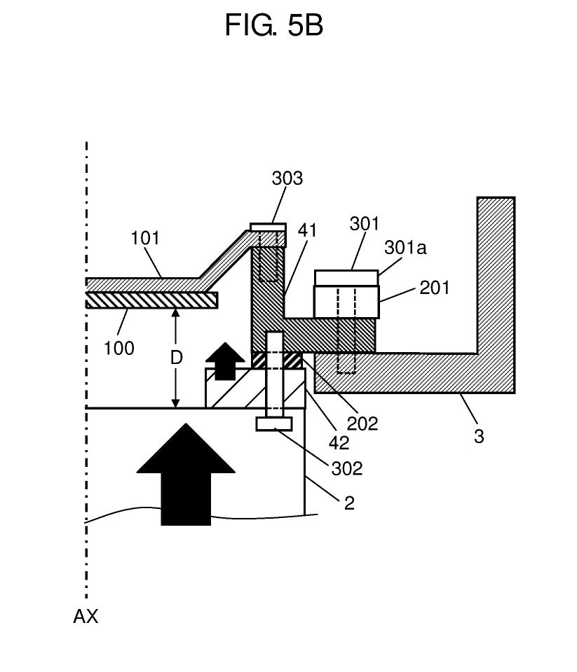

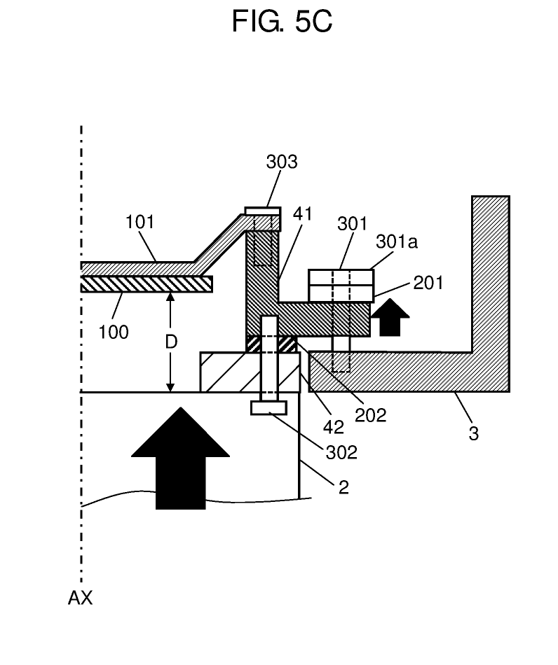

A second exemplary embodiment will be described with reference to FIGS. 5A, 5B, and 5C. FIGS. 5A, 5B, and 5C are schematic diagrams showing a horizontal cross-section around the periphery of the mount ring of the imaging device body taken along line A-A in FIG. 3. Specifically, FIG. 5A is a view showing a state of the imaging device when no impact is applied to an imaging device. FIGS. 5B and 5C are views showing a state of the imaging device when impact is applied to the imaging device due to a fall.

In the second exemplary embodiment, as shown in FIG. 5A, second buffer member 202 is disposed between mount ring 42 and first screw boss part 41a of mount base 41. Second screw member 302 is inserted through second buffer member 202. Second buffer member 202 is formed of elastic hard rubber (e.g., silicon rubber). Second buffer member 202 has substantially the same hardness as that of the first buffer member 201. Second buffer member 202 is disposed between mount ring 42 and first screw boss part 41a of mount base 41 in the state where being compressed. Note that, in the present disclosure, second buffer member 202 may be formed of a coil spring. The compression state of the second buffer member 202 is adjusted by moving second screw member 302 forward and rearward in an axial direction.

Since structures other than the above are the same as those of the first exemplary embodiment, the description thereof is omitted.

In the second exemplary embodiment, when an end part side of lens unit 2 collides with a floor, impact caused by the collision is conveyed to mount ring 42. In this case, in the second exemplary embodiment, an axial center position of second screw member 302 is set to be closer to optical axis AX than an axial center position of first screw member 301 is. For that reason, as shown in FIG. 5B, mount ring 42 firstly deforms second buffer member 202 elastically in a compression direction while sliding rearward in an optical axis AX direction. That is, when mount base 41 slides rearward in the optical axis AX direction, second buffer member 202 absorbs impact to some extent. Accordingly, impact is prevented from concentrating on a joined portion between first screw boss part 41a of mount base 41 and mount ring 42. This prevents that the impact deforms the joined portion and its vicinity between mount base 41 and mount ring 42 or the like. Further, second buffer member 202 absorbs the impact that is conveyed to mount base 41 via mount ring 42, thereby preventing the impact from concentrating on the joined portion between first screw boss part 41a of mount base 41 and case 3. After absorbing the impact, first buffer member 201 and second buffer member 202 return to the compression state shown in FIG. 5A. Accordingly, flange back D is prevented from being changed with respect to the state before the imaging device is fallen down.

Note that, in the case where second buffer member 202 fails to deform elastically enough to absorb the impact, mount base 41 deforms first buffer member 201 elastically in the compression direction while sliding rearward in the optical axis AX direction, as shown in FIG. 5C, like the first exemplary embodiment, so that the remaining impact is further absorbed to some extent. This further prevents that the impact deforms the joined portion and its vicinity between mount base 41 and case 3 or the like. Accordingly, flange back D is further prevented from being changed with respect to the state before the imaging device is fallen down.

Further, by buffering second buffer member 202 and first buffer member 201 one by one, buffer time can be prolonged.

Note that, hardness of second buffer member 202 may be different from that of first buffer member 201, rather than substantially the same as that of first buffer member 201. For instance, if the hardness of second buffer member 202 is smaller than that of first buffer member 201, an amount of the impact absorbed by second buffer member 202 will be increased.

As described above, the imaging device of the second exemplary embodiment further includes second buffer member 202 disposed between mount ring 42 and mount base 41.

Thus, first buffer member 201 and second buffer member 202 can absorb impact more. Therefore, flange back D is more preferably prevented from being changed with respect to the state before the imaging device is fallen down.

### Third Exemplary Embodiment

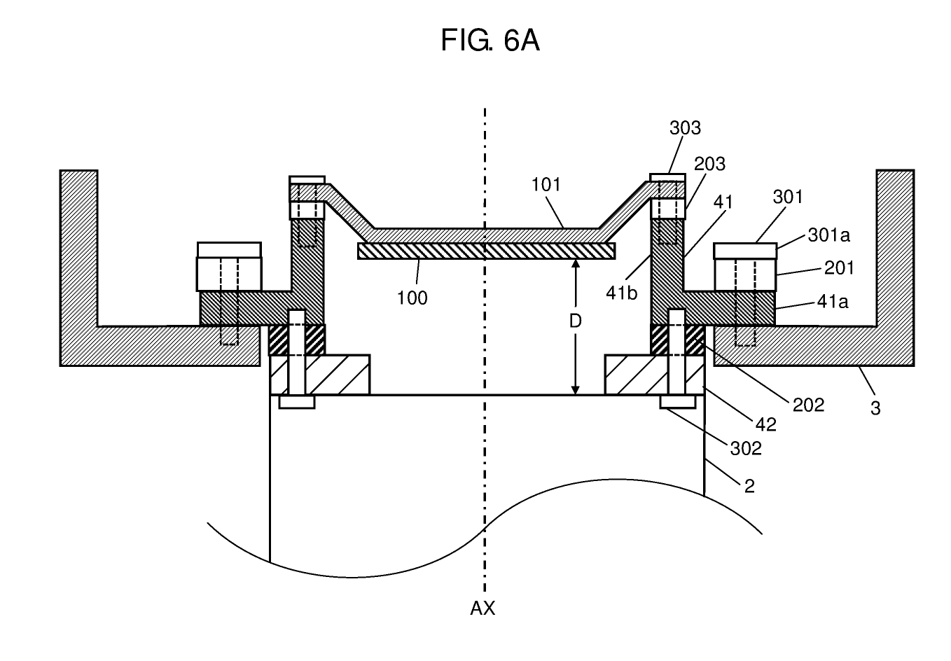

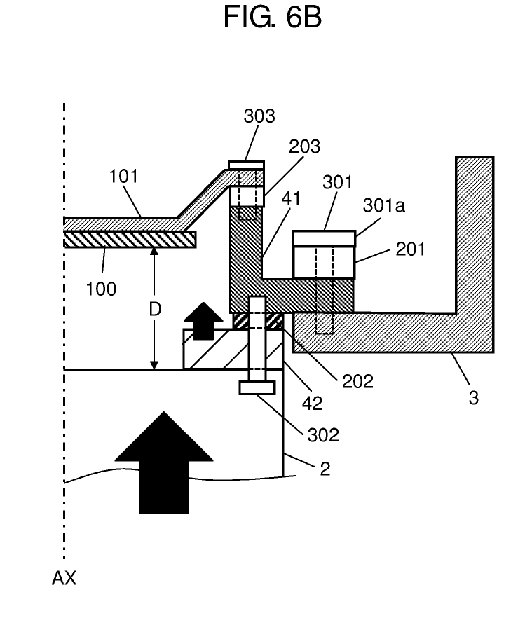

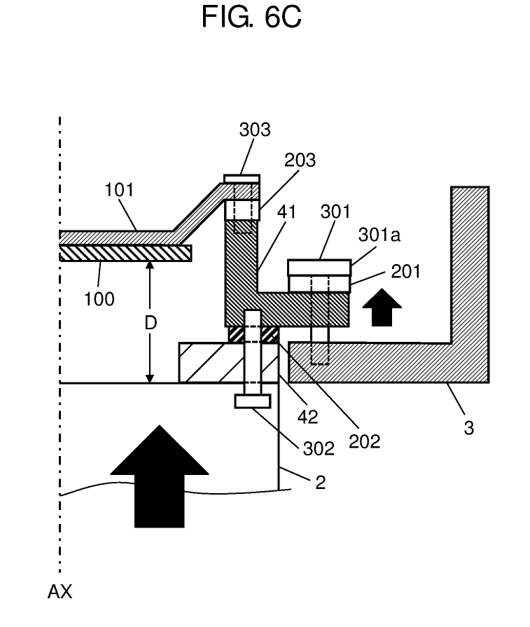

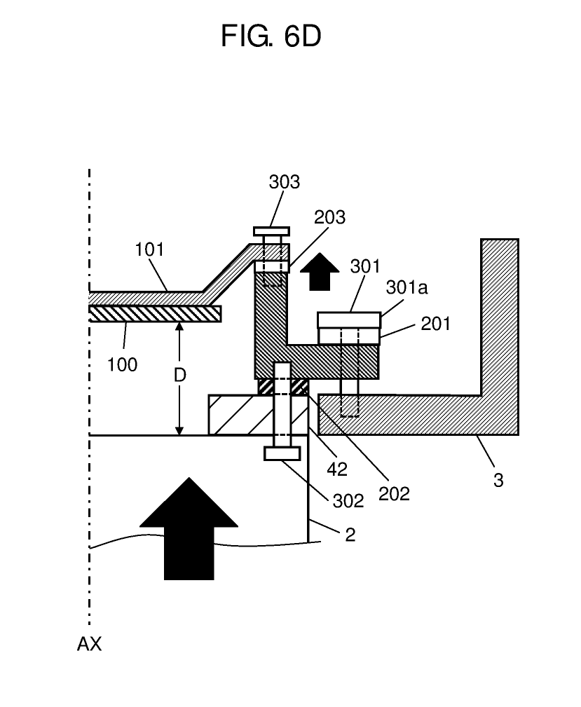

A third exemplary embodiment will be described with reference to FIGS. 6A, 6B, 6C, and 6D. FIGS. 6A, 6B, 6C, and 6D are schematic diagrams showing a horizontal cross-section around the periphery of a mount ring of an imaging device body taken along line A-A in FIG. 3. Specifically, FIG. 6A is a view showing a state of the imaging device where no impact is applied to an imaging device. FIGS. 6B, 6C, and 6D are views showing a state of the imaging device where impact is applied to the imaging device due to a fall.

In the third exemplary embodiment, as shown in FIG. 6A, third buffer member 203 is disposed between a rear end part of second screw boss part 41b of mount base 41 and heat sink 101. Third screw member 303 is inserted through third buffer member 203. Third buffer member 203 is formed of a coil spring. Third buffer member 203 is disposed between the rear end part of second screw boss part 41b of mount base 41 and heat sink 101 in the state where being compressed. The compression state of the third buffer member 203 is adjusted by moving third screw member 303 forward and rearward in an axial direction. Hardness of third buffer member 203 is set to be higher than hardness of first buffer member 201 and second buffer member 202. Note that, in the present disclosure, third buffer member 203 may be formed of elastic hard rubber.

Since structures other than the above are the same as those of the first exemplary embodiment, the description thereof is omitted.

In the third exemplary embodiment, when an end part side of lens unit 2 collides with a floor, first buffer member 201 and second buffer member 202 are elastically deformed to absorb impact caused by the collision to some extent like the second exemplary embodiment as shown in FIGS. 6B and 6C. Accordingly, the impact is prevented from concentrating on a joined portion between mount base 41 and first screw boss part 41a of case 3, thereby preventing that the impact deforms the joined portion and its vicinity between mount base 41 and case 3.

Herein, image sensor element 100 is a component with relatively heavy weight among components disposed in the imaging device. For that reason, when the end part side of lens unit 2 collides with a floor, large force is applied to image sensor element 100 downwardly due to inertia. In the third exemplary embodiment, third buffer member 203 is disposed between the rear end part of second screw boss part 41b of mount base 41 and heat sink 101. Thus, as shown in FIG. 6D, third buffer member 203 deforms elastically and prevents heat sink 101 from receiving the impact caused by the inertia of image sensor element 100. Accordingly, deformation of heat sink 101 is prevented. After absorbing the impact, first buffer member 201, second buffer member 202, and third buffer member 203 return to the compression state shown in FIG. 6A. Therefore, flange back D is prevented from being changed with respect to the state before the imaging device is fallen down.

As described above, the imaging device of the third exemplary embodiment further includes third buffer member 203 disposed between mount base 41 and heat sink 101.

Thus, first buffer member 201, second buffer member 202, and third buffer member 203 can absorb impact. Consequently, flange back D is more preferably prevented from being changed with respect to the state before the imaging device is fallen down.

Further, in the third exemplary embodiment, first buffer member 201 and second buffer member 202 have elastic force smaller than that of third buffer member 203.

Thus, first buffer member 201 and second buffer member 202 can firstly deform elastically, and subsequently third buffer member 203 can deform elastically. That is, impact can be absorbed from the side closer to lens unit 2.

### Fourth Exemplary Embodiment

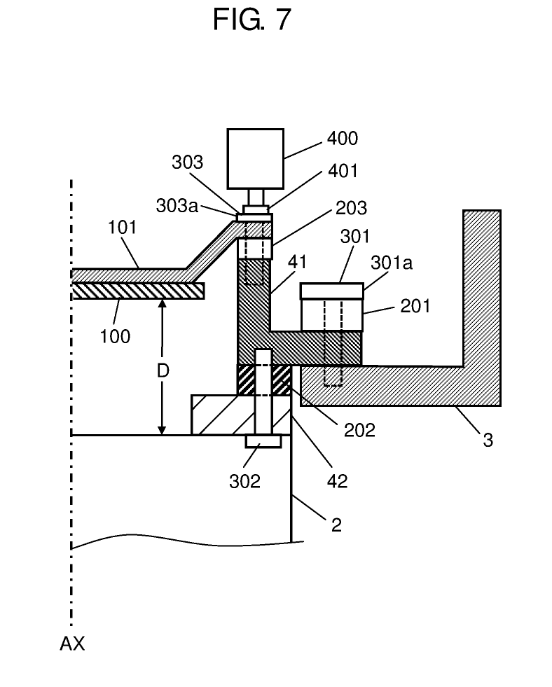

A fourth exemplary embodiment will be described with reference to FIG. 7. FIG. 7 is a schematic diagram showing a horizontal cross-section around the periphery of a mount ring of an imaging device body in the fourth exemplary embodiment. Note that, the cross section position is a position indicated by line A-A in FIG. 3.

Herein, in the case where impact exceeds an assumed value when an end part side of lens unit 2 collides with a floor, buffer members may fail to absorb the impact even if the buffer members are disposed in the respective screw members like the first to third exemplary embodiments, so that flange back D is likely to be changed with respect to the state before the imaging device is fallen down. In order to avoid this situation, the fourth exemplary embodiment has a mechanism for adjusting flange back D.

Specifically, a moving mechanism for moving heat sink 101 is disposed in the fourth exemplary embodiment.

The moving mechanism rotates third screw member 303 to move third screw member 303 forward and rearward in an axial direction, thereby moving heat sink 101 while changing the compression state of third buffer member 203.

Specifically, the moving mechanism has motor 400 and fixed member 401.

Motor 400 is fixed to case 3 or a member not depending on a positional relationship relative to case 3. When a user performs predetermined operation with respect to predetermined operational members included in the imaging device, a control device of the imaging device drives motor 400 according to an operation amount.

Fixed member 401 is coupled with an end part of a driving shaft of motor 400 while being coupled with head 303a of third screw member 303.

According to the above-mentioned structure, when motor 400 is driven, the driving shaft of motor 400 is rotated to rotate fixed member 401, thereby rotating third screw member 303 about a screw axis as a center. Accordingly, heat sink 101 moves in an optical axis direction while changing the compression state of third buffer member 203. If an amount of the movement at this time is adjusted by user's operation of the operation members, flange back D can be adjusted.

### Other Exemplary Embodiments

As mentioned above, the first to fourth exemplary embodiments are described as exemplary art disclosed in this application. However, the art in the present disclosure is not limited to this, but may also be applied to exemplary embodiments in which modifications, replacement, addition, abbreviation, and the like are performed as necessary. Further, the respective components of the above-mentioned first to fourth exemplary embodiments may also be combined to constitute a new exemplary embodiment.

Hereinafter, other exemplary embodiment will be exemplified.

In the above-mentioned exemplary embodiments, the first screw member is first screw member 301. However, in the present disclosure, the first screw member may not be a screw member. The first screw member may be a member that has a locking part disposed on a back side of case 3 and mount base 41 and can attach mount base 41 to case 3.

Further, each buffer member is disposed in the state where being compressed, but may be disposed in the state where being not compressed.

As mentioned above, the exemplary embodiments are described as an exemplary art in the present disclosure. To achieve the above object, the accompanying drawings and the detailed description are provided.

Accordingly, the components illustrated in the accompanying drawings or described in detailed description may include not only essential components for solving problems but also non-essential components for solving problems because they are only used for exemplifying the above art. Therefore, it should not be certified that these non-essential components are essential directly, even if the non-essential components are illustrated in the accompanying drawings or described in detailed description.

Further, the above-mentioned exemplary embodiments intend to exemplify the art in the present disclosure. Therefore, various modifications, replacement, addition, abbreviation, and the like may be performed within the scope of claims or its equivalent range.

The present disclosure can be widely used for an imaging device body to which an interchangeable lens unit is mountable, and an imaging device including the imaging device body and the interchangeable lens unit.

What is claimed is:

1. An imaging device body to which an interchangeable lens unit is mountable, the imaging device body comprising:
a case;
a mount ring to which the lens unit is mountable;
a mount base disposed on a back side of the mount ring and configured to attach the mount ring to the case;
a heat sink disposed on a back side of the mount base;
an image sensor element that is attached to a front side of the heat sink and images an optical image of a subject to generate image data;
a first screw member that has a locking part disposed on a back side of the case and the mount base and attaches the mount base to the case; and
a first buffer member disposed between the locking part of the first screw member and the mount base.

2. The imaging device body according to claim 1, further comprising a second buffer member disposed between the mount ring and the mount base.

3. The imaging device body according to claim 2, further comprising a third buffer member disposed between the mount base and the heat sink.

4. The imaging device body according to claim 3, wherein
the first buffer member and the second buffer member are formed of hard rubber, and
the third buffer member is formed of a coil spring.

5. The imaging device body according to claim 3, wherein
the first buffer member and the second buffer member have hardness smaller than hardness of the third buffer member.

6. The imaging device body according to claim 4, wherein
the first buffer member and the second buffer member have hardness smaller than hardness of the third buffer member.

7. An imaging device comprising:
the imaging device body according to claim 1; and
an interchangeable lens unit being mountable to the mount ring.
